(19) United States
(12) Patent Application Publication
(10) Pub. No.: US 2012/0118669 A1
(43) Pub. Date: May 17, 2012

(54) PORTABLE STEP AND METHOD OF USING SAME

(76) Inventor: Robert Daniel Drye, Concord, NC (US)

(21) Appl. No.: 12/944,921

(22) Filed: Nov. 12, 2010

(51) Int. Cl. E06C 7/00

(52) U.S. Cl. 182/190; 182/189

(57) ABSTRACT

A portable step device includes a stirrup having a base section for placing a foot thereon, and an upper section connected to the base section and extending over the foot when placed on the base. A first adjustable line is connected to the stirrup for extending upwardly from the base section, and has attachment means for attaching the first line to an object above the stirrup. A second adjustable line is connected to the stirrup for extending substantially parallel from the base section, and has attachment means for attaching the second line to an object positioned substantially on a same horizontal plane as the stirrup. The portable step device can be used in the installation of tree steps on a tree stand.

### TECHNICAL FIELD AND BACKGROUND OF THE INVENTION

The present invention relates to a portable step device that can be used in a variety of applications. In one embodiment of the invention, a portable step device can be used in the course of installing steps for a hunting stands.

Hunting stands are widely used today by hunters. Hunting stands can be open or enclosed platforms that are elevated above the ground, giving the hunter an improved view for hunting game. The stands are typically constructed on trees or artificial poles, and steps must be installed on the tree or pole to enable the user to get to the stand located at an elevated position on the tree or pole. Typically, the steps are mounted onto the tree or pole in a staggered orientation, in which the first step is mounted close to the base of the tree, the second step is mounted in an upward and diagonal orientation from the second step, the third step is mounted in an upward and diagonal orientation from the second step, and this staggered pattern is repeated until reaching the desired height at which the stand is mounted.

Such a staggered orientation accommodates the natural climbing motion of the user, however, when originally installing the steps on the tree or pole this staggered orientation results in the installer having to be in an unbalanced and uncomfortable position as one foot must rest at a significantly higher height than the other foot while attempting to install the next steps located above the step or steps he's currently standing on. This unbalanced orientation continues as the hunter works his way up the tree or pole.

### SUMMARY OF THE INVENTION

Therefore, one object of the present invention is to provide a step device that can be used by a person installing steps or a tree stand to keep the person's feet on a substantially level horizontal plane. Another object of the present invention is to provide a step device that is easily transportable. As used throughout this application the term “tree stand” refers generally to all types of elevated hunting stands, whether mounted on trees, poles or any other elevating structure. Likewise the term “tree step” refers generally to any type of structure, whether used on a tree, pole or other elevating structure, on which a person can place a foot on for support.

These and other objects of the present invention can be achieved in the preferred embodiments of the invention described below, in which one embodiment comprises a portable step device comprising a stirrup comprising a base section for placing a foot thereon, and an upper section connected to the base section and extending over the foot when placed on the base. A first adjustable line is connected to the stirrup for extending upwardly from the base section, and has attachment means for attaching the first line to an object above the stirrup. A second adjustable line is connected to the stirrup for extending substantially parallel from the base section, and has attachment means for attaching the second line to an object positioned substantially on a same horizontal plane as the stirrup.

According to another embodiment of the invention, the stirrup is substantially triangular and comprises first, second and third sides. The upper section of the stirrup comprises the first and second sides, and the first and second sides define a vertex where the first and second sides meet. The base section comprises the third side, and the third side is connected to the first and second sides. The first adjustable line can be connected at the vertex defined by the first and second sides, and the second adjustable line is connected to the first side.

According to another embodiment of the invention, the first adjustable line can be attached in a fixed position at the vertex.

According to another embodiment of the invention, the second adjustable line can be freely moveable along the first side.

According to another embodiment of the invention, a first buckle can be connected to the first line for adjusting the length of the first line.

According to another embodiment of the invention, a second buckle can be connected to the second line for adjusting the length of the second line.

According to another embodiment of the invention, a first plurality of loops can be attached to the first line, and a second plurality of loops can be attached to the second line to provide a means for adjusting the length of the effective length of the first and second lines.

According to another embodiment of the invention, the first line attachment means comprises a loop formed at an end of the first line.

According to another embodiment of the invention, the second line attachment means comprises a loop formed at an end of the second line.

According to another embodiment of the invention, the first line and second lines can be ropes and/or straps.

According to another embodiment of the invention, the stirrup can be made of a high tenacity polyester fiber, nylons, a fiber filled composite, an engineering plastic or a suitable metal material.

According to another embodiment of the invention, the first and second lines can be made of a high tenacity polyester fiber such as the fiber sold by Samson under the name TENEX-TEC, nylons, high molecular weight polyethylene such as the fiber sold under the name SPECTRA, high performance polyester such as the fibers sold under the name VECTRAN or DACRON, or ultra-high molecular weight polyethylene such as the fiber sold under the name DYNEEMA.

According to another embodiment of the invention, a portable step device comprises a triangular stirrup for supporting a foot of a user, the stirrup having first, second and third sides, in which the first and second sides define a vertex where the first and second sides meet. A first adjustable line is connected to the stirrup proximate the vertex of the first and second sides, in which the first adjustable line is extendable in an upwardly direction from the stirrup, and includes attachment means for attaching the first line to an object above the stirrup. A second adjustable line is connected to the stirrup, in which the second adjustable line is extendable in a substantially parallel direction from the stirrup, and includes attachment means for attaching the second line to an object positioned substantially on a same horizontal plane as the stirrup.

According to another embodiment of the invention, the first adjustable line can be attached in a fixed position at the vertex.

According to another embodiment of the invention, the second adjustable line is moveable along the first side.

According to another embodiment of the invention, a method of installing steps on a tree includes the steps of providing a portable step comprising a stirrup comprising a base section for placing a foot thereon, and an upper section connected to the base section and extending over the foot when placed on the base. A first adjustable line is connected to the upper section for extending upwardly from the base section, and has attachment means for attaching the first line to an object above the stirrup. A second adjustable line is connected to the stirrup for extending substantially parallel from the base section, and has attachment means for attaching the second line to an object positioned substantially on a same horizontal plane as the stirrup. First and second tree steps are mounted on a tree, and the first step is proximate the base of the tree, and the second step is mounted above and substantially diagonal to the first step. The first adjustable line is attached to the second step, and the second adjustable line is attached to the first step. The length of the first line and the second line are adjusted such that the stirrup is positioned substantially on the same horizontal plane as the stirrup. The user's positions one foot on the first tree step, and positions the other on the stirrup.

According to another embodiment of the invention, a third tree step is mounted above the first step substantially in a same vertical plane as the first step, and a fourth tree step is mounted above the second and third steps, in substantial vertical alignment with the second step.

According to another embodiment of the invention, the first line is removed from the second step, the second line is removed from the first step, the first adjustable line is attached to the third step, the second adjustable line is attached to the second step. The length of the first line and the second line are adjusted such that the stirrup is positioned substantially on the same horizontal plane as the second step.

### BRIEF DESCRIPTION OF THE DRAWINGS

FIG. 1 is a perspective view of portable step according to a preferred embodiment of the invention;

FIG. 2 is another perspective view of the portable step of FIG. 1;

FIG. 3 is an environmental perspective view illustrating a method of using the portable step of FIG. 1;

FIG. 4 is another environmental perspective view illustrating a method of using the portable step of FIG. 1;

FIG. 5 is a perspective view of a portable step according to another preferred embodiment of the invention; and

FIG. 6 is an environmental perspective view illustrating a method of using the portable step of FIG. 5;

### DESCRIPTION OF THE PREFERRED EMBODIMENTS OF THE INVENTION AND BEST MODE

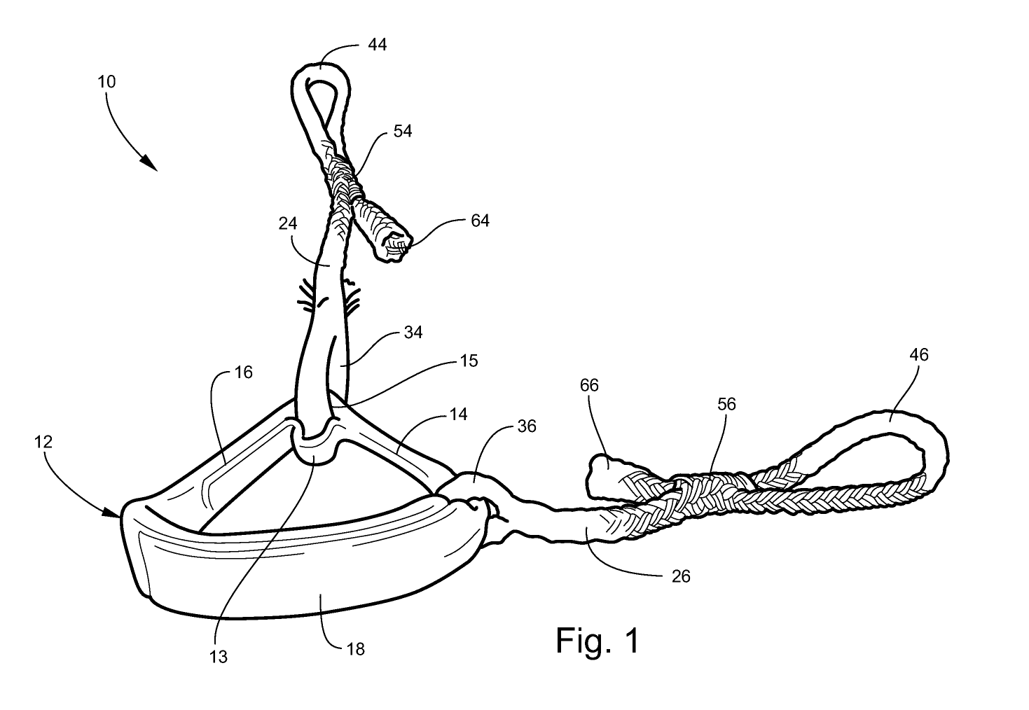

A portable step according to a preferred embodiment of the invention is illustrated in FIG. 1, and shown generally at reference numeral 10. As shown in FIG. 1, the portable step 10 comprises a substantially triangular stirrup 12 having three sides 14, 16, 18, an adjustable first line 24 attached at the vertex 15 of the first side 14 and the second side 16, and a second adjustable line 26 attached on the second side 16.

The stirrup 12 includes a base section comprised of the third side 18 on which a user's foot is to be placed, and an upper section comprised of the first and second sides 14, 16 that extend over the user's foot and help keep it on the base section 18. The stirrup 12 is preferably made of a strap comprised of high strength fiber, such as the high-tenacity polyester fiber sold by Samson under the name TENEX-TEC, a fiber filled composite, an engineering plastic or a suitable metal material. Four or more layers of the strap can be wrapped over on each other and stitched together to make the base 18 hard and stiff.

The first and second adjustable lines 24, 26 are preferably made of a high strength fiber, such as the high-tenacity polyester fiber sold by Samson under the name TENEX-TEC, nylons, high molecular weight polyethylene such as the fiber sold under the name SPECTRA, high performance polyester such as the fibers sold under the name VECTRAN or DACRON, or ultra-high molecular weight polyethylene such as the fiber sold under the name DYNEEMA. Break testing conducted on the portable step 10 indicates that it can withstand a peak load of 9,940 pounds.

The first rope 24 is connected at the vertex 15 of the first and second sides 14, 16 by a first loop 34 woven at the first end of the rope 24. The rope 24 is held in place proximate the vertex 15 by a retaining layer 13 sewn on the undersurface of the sides 14, 16 of the upper section of the stirrup 12. The second rope 26 is connected to the first side 14 of the upper section of the stirrup 12 by a first loop 36 woven at the first end of the rope 26. In an alternative embodiment, the second rope 26 can be sandwiched within the layers of the base 18. In yet another alternative embodiment, the first rope 24 and the second rope are connected to the stirrup by being sandwiched within the layers of the base 18.

As shown in FIG. 1, the loop 36 on rope 26 is positioned proximate the corner of the first side 14 and the base 18. The rope 26 can slide freely along the first side 14, but is prevented from moving over onto the second side 16 by the retaining layer 13 and loop 34 of rope 24, and is prevented from moving onto the base 18 due to the multiple layering of strap that form base 18. Each of the loops 34, 36 can be formed by a permanent eye splice woven in the ropes 24, 26, such as is used in Whoopie slings.

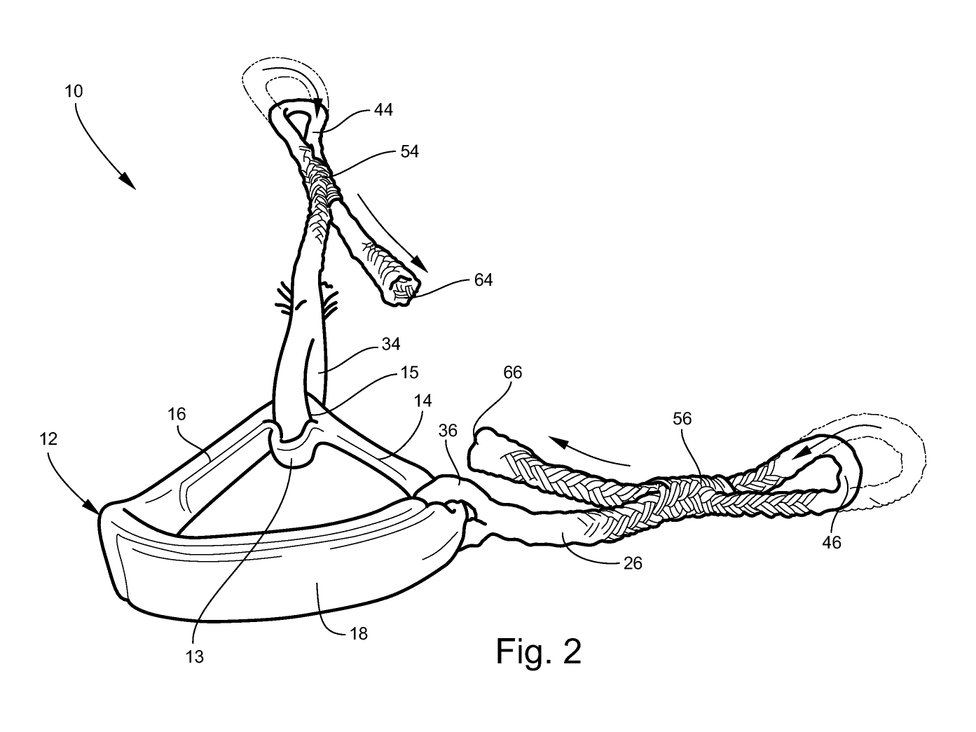

The first rope 24 has a second loop 44 formed at the second end of the rope 24, by an adjustable eye split 54 woven on the rope 24, such as is used in Whoopie slings. As such, the length of the rope 24 can be adjusted by pulling the dead end 64 of the rope through the adjustable eye split 54, as shown in FIG. 2. By pulling the dead end 64 through the adjustable eye split 54 in the direction illustrated in FIG. 2, the effective length of the rope 24 is shortened. By pulling on the loop 44 on the side of the eye split 54 opposite the dead end 64, the effective length is increased. Likewise, the second rope 26 has a second loop 46 formed at the second end of the rope 26, by an adjustable eye split 56 woven on the rope 26. As such, the length of the rope 26 can be adjusted by pulling the dead end 66 of the rope through the adjustable eye split 56, as shown in FIG. 2. The dead ends 64, 66 are thicker than the rest of the ropes 24, 26 and have a length of approximately four to six inches. As such, the dead ends 64, 66 cannot be pulled through the adjustable eye splits 54, 56, respectively, thereby preventing the loops 44, 46 from coming undone.

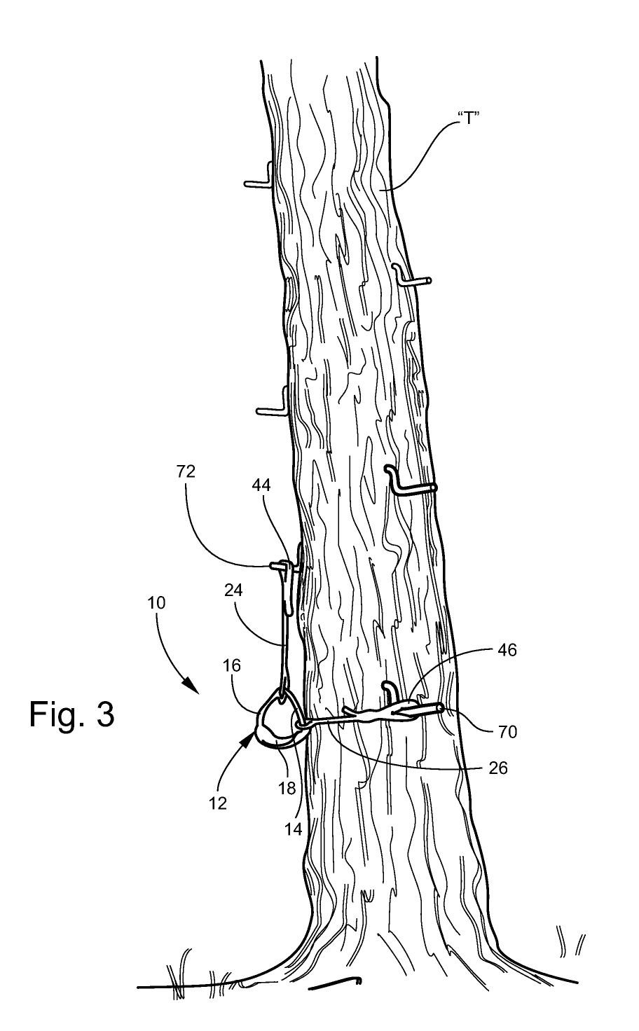

In a preferred method of using the portable step 10, the portable step 10 is used in the course of installing tree steps on a tree for a hunting stand, in which the tree steps are to be installed in a staggered orientation, in which the first step 70 is mounted close to the base of the tree “T”, the second step 72 is mounted in an upward and diagonal orientation from the second step, and this staggered pattern is repeated until reaching the desired height of the tree “T”. As shown in FIG. 3, the first rope 24 is attached to the second tree step 72 by positioning the second loop 44 of the first rope over the tree step 72. The second rope is attached to the first tree step 70.

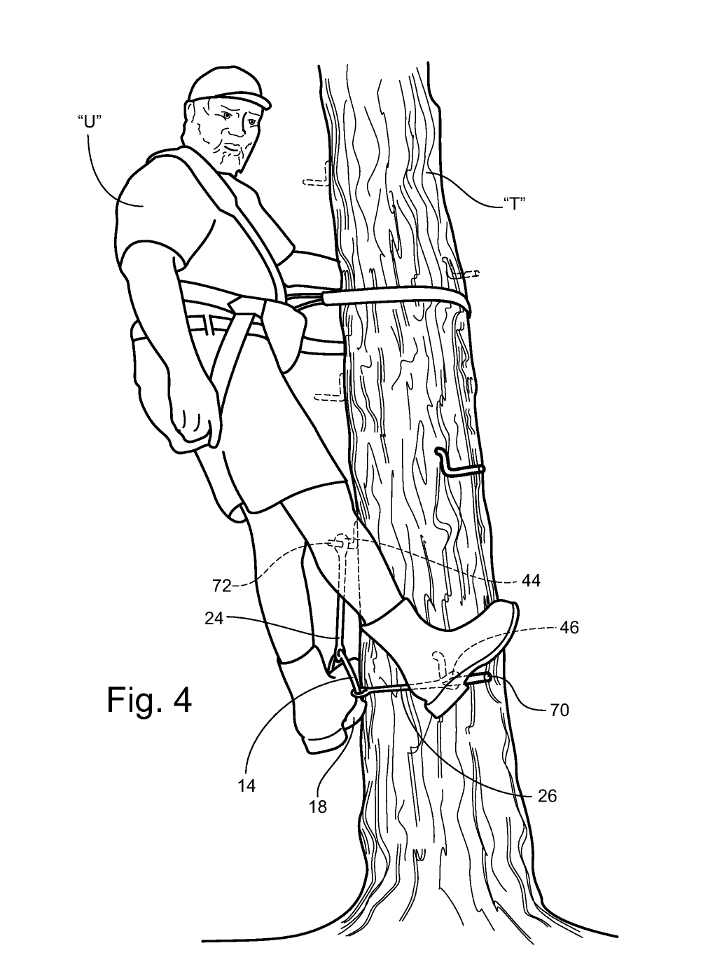

The user can adjust the length of the ropes 24, 26, either to shorten or lengthen as needed, such that the stirrup 12 lies in substantially the same horizontal plane as the first tree step 70, and along substantially the same vertical plane as the second tree step 72, as shown in FIG. 3. In this position, the portable step 10 provides optimum stability for the user “U”, as he places one foot on the first tree step 70, and another foot in the stirrup 12 of the portable step 10, as shown in FIG. 4. As such, the feet of the user “U” are kept substantially level to one another, allowing the user “U” to mount additional tree steps higher up the tree “T”. As additional tree steps are mounted above the first and second tree steps 70, 72, the user can remove the portable step 10 from the first and second tree steps 70, 72, and repeat the process by positioning the portable step 10 on tree steps higher up until tree steps are mounted at the desired height of the tree “T” where the tree stand's platform is to be mounted.

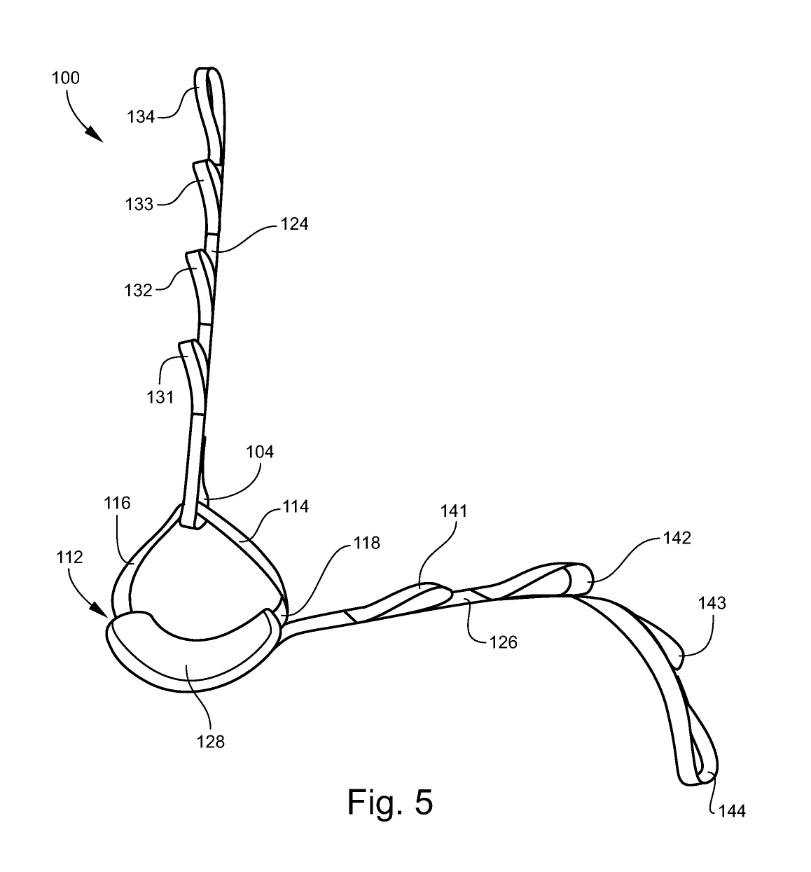

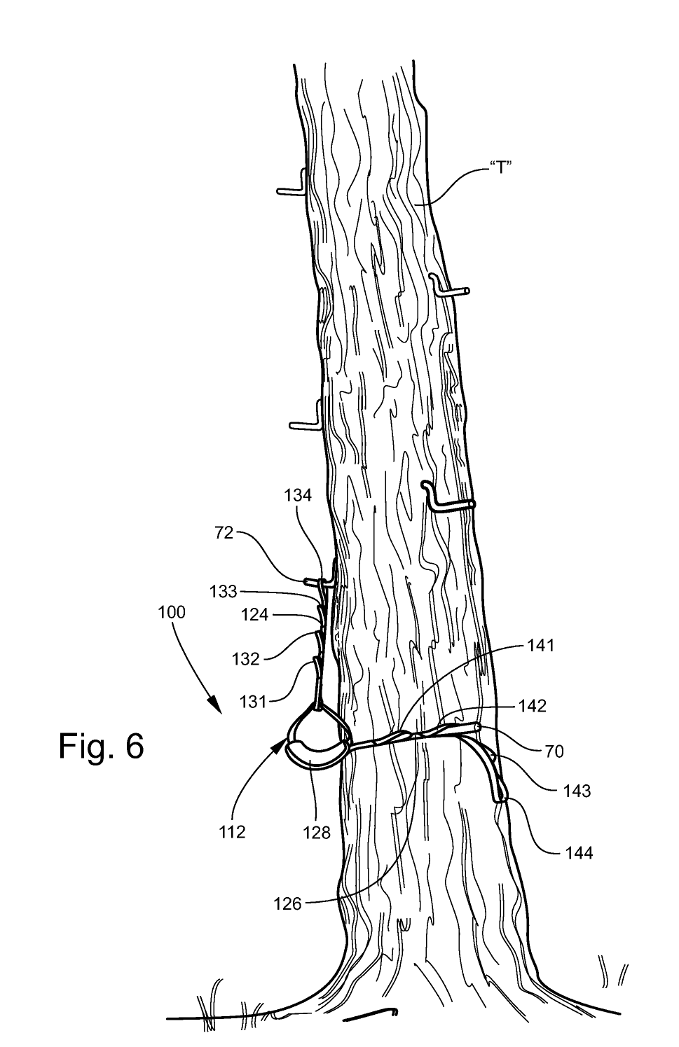

A portable step according to another preferred embodiment of the invention is illustrated in FIGS. 5 and 6, and shown generally at reference numeral 100. As shown in FIG. 5, the portable step 100 comprises a substantially triangular stirrup 112 having three sides 114, 116, 118, a first strap 124 attached at the vertex 115 of the first side 114 and the second side 116, and a second strap 126 attached to stirrup 112 at the bottom surface of the third side 118. The first strap 124 is connected at the vertex 115 of the first and second sides 114, 116 by a connecting loop 104 attached at the first end of the strap 124 and wrapped around the vertex 115 of the first and second sides 114, 116.

The stirrup 112 includes a base section 128 attached to the upper surface of the third side 118, on which a user's foot is placed. The first and second sides 114, 116 extend over the user's foot, and help keep the foot on the base 128.

The first strap 124 has four loops 131,132,133,134 attached thereon, and likewise, the second strap 126 has four loops 141,142,143,144 attached thereon. As shown in FIG. 6, the straps 124, 126 can be attached to tree steps 70, 72 by positioning one of the four loops 131,132,133,134, 141,142,143,144 on each strap 124, 126, respectively, over tree steps 70, 72. As such, the effective length of the straps 124, 126 can be adjusted by the user selecting which one of the four loops 131,132,133,134, 141,142,143,144 on each strap to be positioned over the tree steps 70, 72.

For example, if maximum length in strap 124 is desired, loop 134, the loop farthest from the stirrup 112, is positioned over the tree step 72. If the minimal amount of length is desired, loop 131, the loop closest to the stirrup 112, is positioned over the tree step. Preferably, the user selects loops that will result in the first strap 124 hanging in substantial vertical alignment with the stirrup 112 and the second tree step 72, and substantial horizontal alignment with the first tree step 70, as shown in FIG. 6, in which loop 134 of the first strap 124 is positioned over the second tree step 72, and loop 142 of the second strap is positioned over the first tree step 70. Alternatively, the multiple loops 131,132,133, 141,142,143 on straps 124, 126, respectively, can be removed and replaced with a buckle on each of straps 124, 126 for adjusting the length of each strap 124, 126.

A portable step and a method of using same are described above. Various changes can be made to the invention without departing from its scope. The above description of the preferred embodiments and best mode of the invention are provided for the purpose of illustration only and not limitation—the invention being defined by the following claims and equivalents thereof.

What is claimed is:

1. A portable step device comprising:
(a) a stirrup comprising a base section for placing a foot thereon, and an upper section functionally connected to the base section and extending over the foot when placed on the base;
(b) a first adjustable line functionally connected to the stirrup for extending upwardly from the base section, and having attachment means for attaching the first line to an object above the stirrup; and
(c) a second adjustable line functionally connected to the stirrup for extending substantially parallel from the base section, and having attachment means for attaching the second line to an object positioned substantially on a same horizontal plane as the stirrup.

2. A portable step device according to claim 1, wherein:
(a) the stirrup is substantially triangular and comprises first, second and third sides;
(b) the upper section comprises the first and second sides, the first and second sides defining a vertex where the first and second sides meet;
(c) the base section comprises the third side, the third side connected to the first and second sides;
(d) the first adjustable line is connected at the vertex defined by the first and second sides; and
(e) the second adjustable line is connected to the first side.

3. A portable step device according to claim 2, wherein the first adjustable line is attached in a fixed position at the vertex.

4. A portable step device according to claim 3, wherein the second adjustable line is moveable along the first side.

5. A portable step device according to claim 1, comprising a first buckle connected to the first line for adjusting the length of the first line.

6. A portable step device according to claim 5, comprising a second buckle connected to the second line for adjusting the length of the second line.

7. A portable step device according to claim 1, further comprising a first plurality of loops attached to the first line, and a second plurality of loops attached to the second line.

8. A portable step device according to claim 1, wherein the first line attachment means comprises a loop formed at an end of the first line.

9. A portable step device according to claim 8, wherein the second line attachment means comprises a loop formed at an end of the second line.

10. A portable step device according to claim 1, wherein the first line and second lines are selected from the group consisting of ropes and straps.

11. A portable step device according to claim 1, wherein the stirrup comprises nylon.

12. A portable step device according to claim 11, wherein the first and second lines comprise nylon.

13. A portable step device comprising:
(a) a triangular stirrup for supporting a foot of a user, the stirrup comprising first, second and third sides, wherein the first and second sides define a vertex where the first and second sides meet;
(b) a first adjustable line connected to the stirrup proximate the vertex of the first and second sides, wherein the first adjustable line is extendable in an upwardly direction from the stirrup, and includes attachment means for attaching the first line to an object above the stirrup; and
(c) a second adjustable line connected to the stirrup, wherein the second adjustable line is extendable in a substantially parallel direction from the stirrup, and includes attachment means for attaching the second line to an object positioned substantially on a same horizontal plane as the stirrup.

14. A portable step device according to claim 13, wherein the first adjustable line is attached in a fixed position at the vertex.

15. A portable step device according to claim 14, wherein the second adjustable line is moveable along the first side.

16. A method of installing steps on a tree comprising the steps of:
(a) providing a portable step comprising:
(i) a stirrup comprising a base section for placing a foot thereon, and an upper section connected to the base section and extending over the foot when placed on the base;
(ii) a first adjustable line connected to the upper section for extending upwardly from the base section, and having attachment means for attaching the first line to an object above the stirrup; and
(iii) a second adjustable line connected to the stirrup for extending substantially parallel from the base section, and having attachment means for attaching the second line to an object positioned substantially on a same horizontal plane as the stirrup.
(b) mounting first and second tree steps on a tree, wherein the first step is proximate the base of the tree, and the second step is mounted above and substantially diagonal to the first step:
(c) attaching the first adjustable line to the second step; and
(d) attaching the second adjustable line to the first step,
(e) adjusting the length of the first line and the second line whereby the stirrup is positioned substantially on the same horizontal plane as the stirrup;
(e) positioning a user's first foot on the first step, and positioning the user's second foot on the stirrup.

17. A method according to claim 16, further comprising the steps of:
(a) mounting a third tree step above the first step substantially in a same vertical plane as the first step; and
(b) mounting a fourth tree step above the second and third steps, and substantially in a same vertical plane as the second step.

18. A method according to claim 17, further comprising the steps of:
(a) removing the first line from the second step;
(b) removing the second line from the first step;
(c) attaching the first adjustable line to the third step; and
(d) attaching the second adjustable line to the second step; and
(e) adjusting the length of the first line and the second line whereby the stirrup is positioned substantially on the same horizontal plane as the second step.

19. A method according to claim 17, wherein the first line attachment means comprises a loop formed at an end of the first line.

20. A method according to claim 19, wherein the second line attachment means comprises a loop formed at an end of the second line.
